(19) United States
(12) Patent Application Publication
(10) Pub. No.: US 2010/0326252 A1
(43) Pub. Date: Dec. 30, 2010

(54) PANEL SAW MACHINE FOR PANELS MADE OF WOOD OR SIMILAR MATERIAL

(75) Inventor: Piergiorgio Benuzzi, Bologna (IT)

Correspondence Address: Pearne & Gordon LLP, 1801 East 9th Street, Suite 1200, Cleveland, OH, 44114-3108, US

(73) Assignee: GIBEN INTERNATIONAL S.P.A., 40065 Pianoro (Bologna) (IT)

(21) Appl. No.: 12/864,993

(22) PCT Filed: Jan. 30, 2009
(86) PCT No.: PCT/IB2009/050377

§ 371 Date: Jul. 28, 2010

(30) Foreign Application Priority Data
Jan. 31, 2008 (IT) BO2008A000066

(51) Int. Cl. B27B 5/065; B23D 47/08; B23D 47/04; B27B 5/075

(52) U.S. Cl. 83/422; 83/424; 83/455; 83/488; 83/495

(57) ABSTRACT

A panel saw machine (2) for panels (1) made of wood or similar materials comprises: a horizontal table (3) for supporting the panels (1); means (4) for advancing the panels (1) along a feed line (A) and mobile in a direction parallel to and along the horizontal table (3); a straight cutting unit (5) transversal to the feed line (A) and comprising a base (10), presser means (6) for holding down the panels (1), and a first saw blade (7) mobile in both directions and protruding lengthways from a slot made in the horizontal table (3) in such a such a way as to cut the panels (1) along a line (T) transversal to the feed line (A); the cutting unit (5) also comprises a carriage (8) which rotatably mounts the first blade (7) and which is slidably connected to guide means (9) associated with the base (10) and adjustment means (14) acting on the carriage (8) and designed to enable the carriage (8) to move vertically in both directions along a line (Z) perpendicular to the transversal line (T).

### TECHNICAL FIELD

This invention relates to a panel saw machine for panels made of wood or similar materials.

### BACKGROUND ART

At present, panel saw machines essentially comprise:
a main frame comprising a first horizontal table;
means for advancing the panels along a defined feed line and usually consisting of a crossbar mobile in parallel along said first horizontal table and equipped with clamps used for gripping the panel or panels to be sawn;
a straight cutting unit transversal to the feed line and comprising a beam that mounts one or two hold-down bars for pressing down on the panels, and a carriage, positioned near the beam and equipped with at least one mobile circular blade designed to cut the panels along a line transversal to the beam and usually passing between the hold-down bars;
a second table, positioned in front of the cutting unit, downstream of the cutting unit relative to the panel feed line on the first horizontal table, for supporting the panels and/or the respective panel lengths obtained by cutting.

Over time, these panel saw machines have been continually improved in all the parts described above in order to increase productivity, enhance panel cutting quality and make machine operation safer.

Thus, if on the one hand targets of high quality have been achieved, on the other, machine purchase and maintenance costs have risen proportionately.

In practice, increased costs have restricted the range of potential machine buyers to companies with high productivity requirements that can quickly amortise the high initial cost of the machines, while individual craftsmen, one-person concerns and medium- to low-productivity companies cannot in most cases afford to buy machines of this kind.

For example, the above mentioned blade unit or carriage, which this specification refers to in particular, usually consists of a mobile unit or carriage that mounts the main blade and, normally, a smaller blade known as “scoring blade”. The two blades protrude from a slot made in the first horizontal table.

The carriage is usually driven by a motor which enables it to move along the cutting axis, transversal to the feed line, and mounts at least one other motor to drive the main and scoring blades and the related auxiliary operating elements.

This structure, in its entirety, makes the carriage extremely heavy which means, in turn, that it requires a suitably sized mounting base made from metal fabrications with high-strength guides and a plurality of machined features to allow the passage of cables and conduits for power and air supply lines (to release the blade and extract sawdust) along the whole cutting front.

As a result, this structure is extremely expensive, takes a very long time to assemble and, especially for the electrical and air systems, requires frequent maintenance which must be carried out by specialised personnel and which increases the overall cost of running the machine.

### DISCLOSURE OF THE INVENTION

The aim of this invention is therefore to overcome the above mentioned disadvantages by providing a panel saw machine for panels made of wood or similar materials having an extremely compact, lightweight, reliable and inexpensive blade unit with a mounting and drive structure that is simple and practical so as to reduce the assembly and maintenance costs of the blade unit.

According to the invention, this aim is achieved by a panel saw machine, especially a panel saw machine for panels made of wood or similar materials, comprising the technical characteristics described in one or more of the appended claims.

### BRIEF DESCRIPTION OF THE DRAWINGS

The technical characteristics of the invention, with reference to the above aims, are clearly described in the claims below and its advantages are more apparent from the detailed description which follows, with reference to the accompanying drawings which illustrate a preferred embodiment of the invention provided merely by way of example without restricting the scope of the inventive concept, and in which:

FIG. 1 is a schematic top plan view of a panel saw machine according to the invention, for panels made of wood or similar materials;

FIG. 2 illustrates the panel saw machine of FIG. 1 in a schematic front view from P, with some parts cut away in order to better illustrate others;

FIG. 3 is a front view with some parts cut away to better illustrate others, of a detail P1 from FIG. 2;

FIG. 4 is a top plan view, with some parts cut away and others in cross section, of the detail of FIG. 3;

FIG. 5 is a side view from P3 of the detail of FIG. 3, with some parts cut away and others in cross section;

FIG. 6 is a side view from P4 of the detail of FIG. 3, with some parts cut away and others in cross section;

### DETAILED DESCRIPTION OF THE PREFERRED EMBODIMENTS OF THE INVENTION

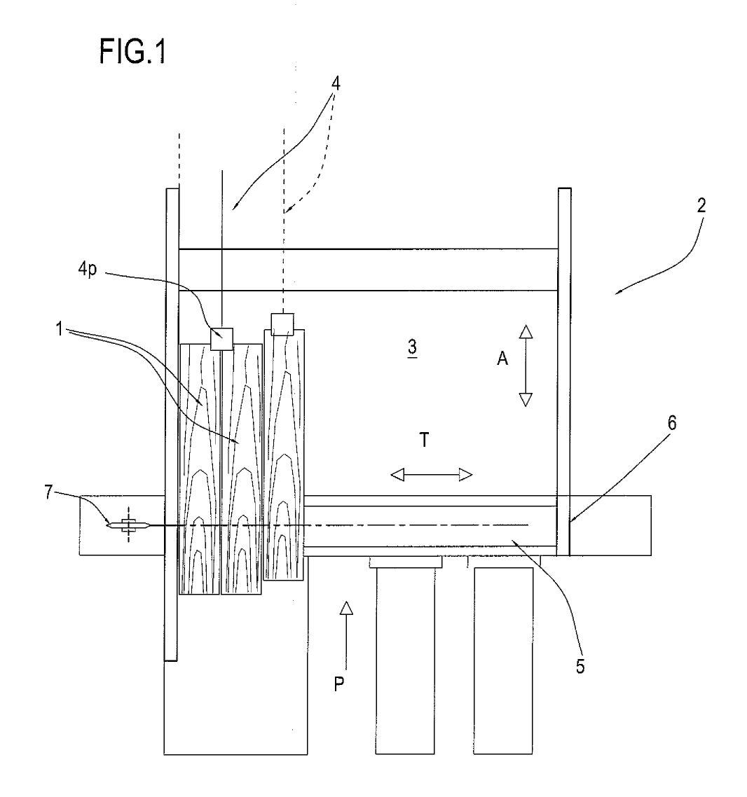

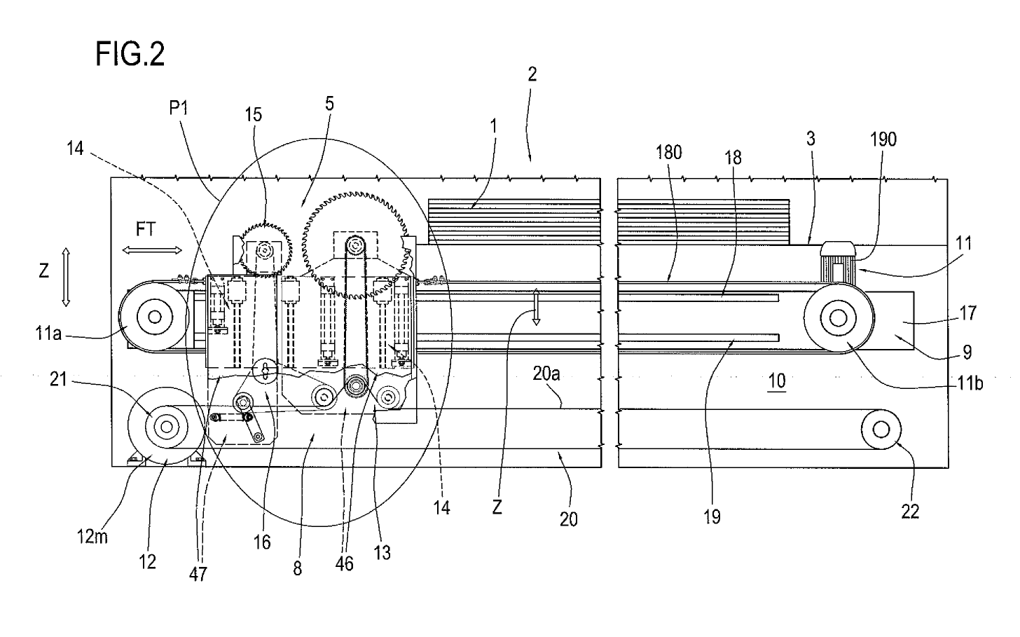

With reference to the accompanying drawings, in particular FIGS. 1 and 2, the panel saw machine according to the invention is used for cutting panels 1 made of wood or similar materials.

This panel saw machine, labelled 2 in its entirety, essentially comprises:
a horizontal table 3 for supporting the panels 1;
means 4 for advancing the panels 1 along a feed line A and mobile in a direction parallel to and along the horizontal table 3 (illustrated schematically with gripper clamps 4p, being of customary type and not strictly relevant to this invention);
a straight cutting unit 5 transversal to the feed line A and comprising at least one base 10, presser means 6 for holding down re panels 1, and a first saw blade 7 positioned close to the presser means 6, mobile in both directions and protruding lengthways from a slot 3a made in the horizontal table 3 in such a way as to cut the panels 1 along a line T transversal to the feed line A.

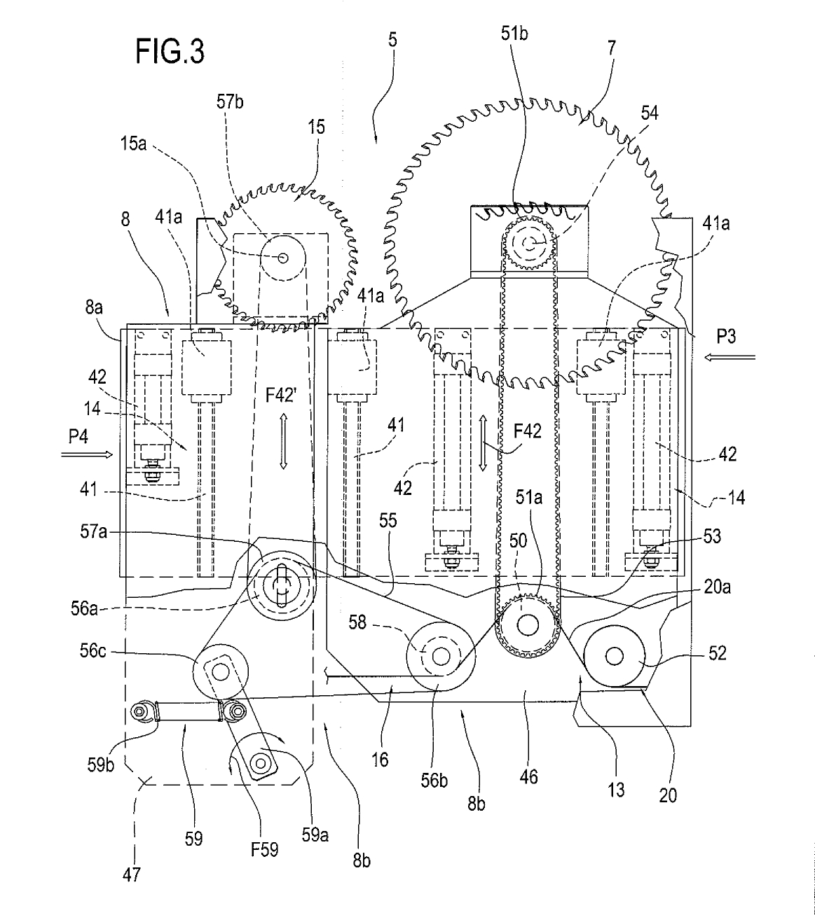

As illustrated in FIGS. 2 and 3, the cutting unit 5 also comprises:
a carriage 8 which rotatably mounts the first blade 7 and which is slidably connected to horizontal guide means 9 associated with the mounting base defined by a vertical wall 10;
adjustment means 14 acting on the carriage 8 and designed to enable the carriage 8 to move vertically in both directions along a line Z perpendicular to the transversal line T (see arrows FT in FIG. 2).

Besides the above, the cutting unit 5 comprises first means 11 for moving the carriage 8, allowing the carriage 8 to move in both directions along a transversal line T, and second means 12 for driving the first blade 7, these second means being located under the horizontal work table 3, associated with the mounting wall 10, and connected kinematically through first motion transmission means 13 to the first blade 7 in such a way as to allow the first blade 7 to rotate continuously, irrespective of the position of the latter along the transversal cutting line T.

Again with reference to FIGS. 2 and 3, the carriage 8 may have rotatably mounted on it a second blade 15, or scoring blade, positioned alongside the first, main blade 7, and connected to the second drive means 12 through second drive transmission means 16 in turn connected to the above mentioned first drive transmission means 13 and mounted on the carriage 8.

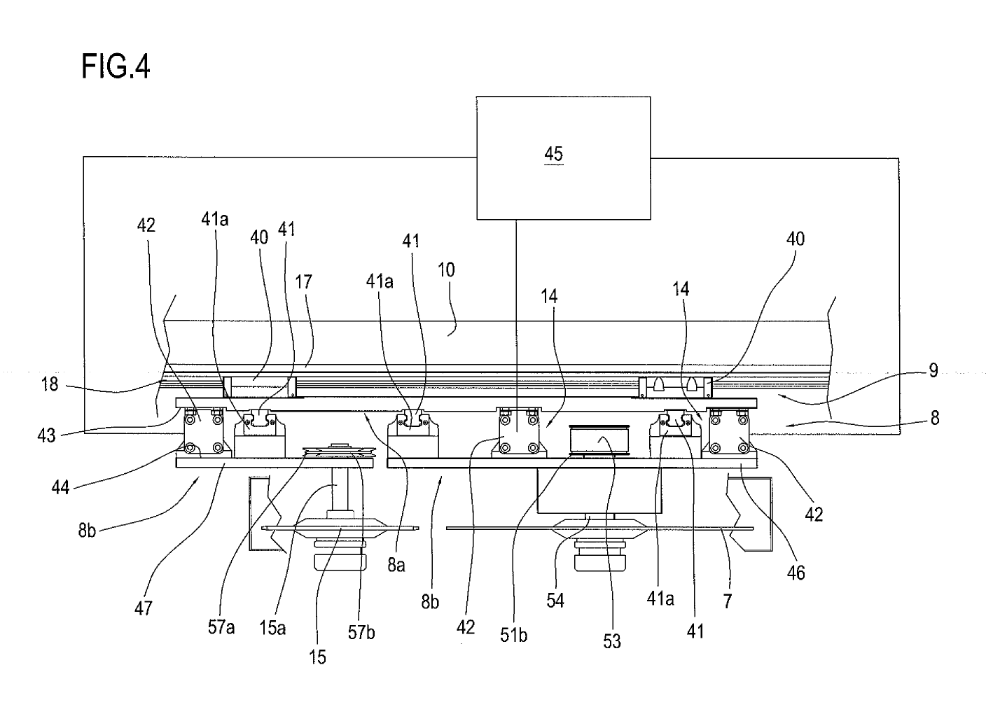

Looking more closely at the technical details (see FIGS. 2 and 4) the aforementioned guide means 9 comprise a horizontal plate 17 provided with a pair of horizontal guides 18 and 19 to which the carriage 8 is slidably constrained.

The first drive means 11 comprise a pair of first pulleys 11a and 11b, mounted at the respective ends of the cutting unit 5 and rotatably constrained to the horizontal plate 17.

Trained around the pair of first pulleys 11a and 11b there is a first endless belt 180 for driving the carriage 8 and associated, at its free ends, with the carriage 8 itself.

Further, the pulley labelled 11b is connected to a respective first drive unit 190 (for example, a customary geared motor) for driving the pulleys 11a and 11b and, hence, the carriage 8 by pushing and/or pulling.

The aforementioned second means 12 for driving the two blades 7 and 15 comprise a second drive unit 12m mounted close to the mounting wall 10 (positioned on a tread surface under the table 3) and used to drive a second endless belt or cable 20 (preferably of steel) trained around at least one second pair of pulleys 21 and 22 rotatably associated with the ends of the wall 10 in such a way that the sections of the second belt 20 are positioned at least along the full extent of the cutting unit 5.

It should be underlined that the belts or cables described in this text and illustrated in the accompanying drawings may be of any kind, that is to say, toothed belts, flat belts, Vee belts or cables made of any material, without thereby restricting the scope of the inventive concept.

The upper section 20a of the second belt 20 is engaged with the first drive transmission means 13 positioned on the carriage 8 (as will become clearer as this description continues) in order to drive the first blade 7 independently of the movement and position of the carriage 8 along the cutting unit 5.

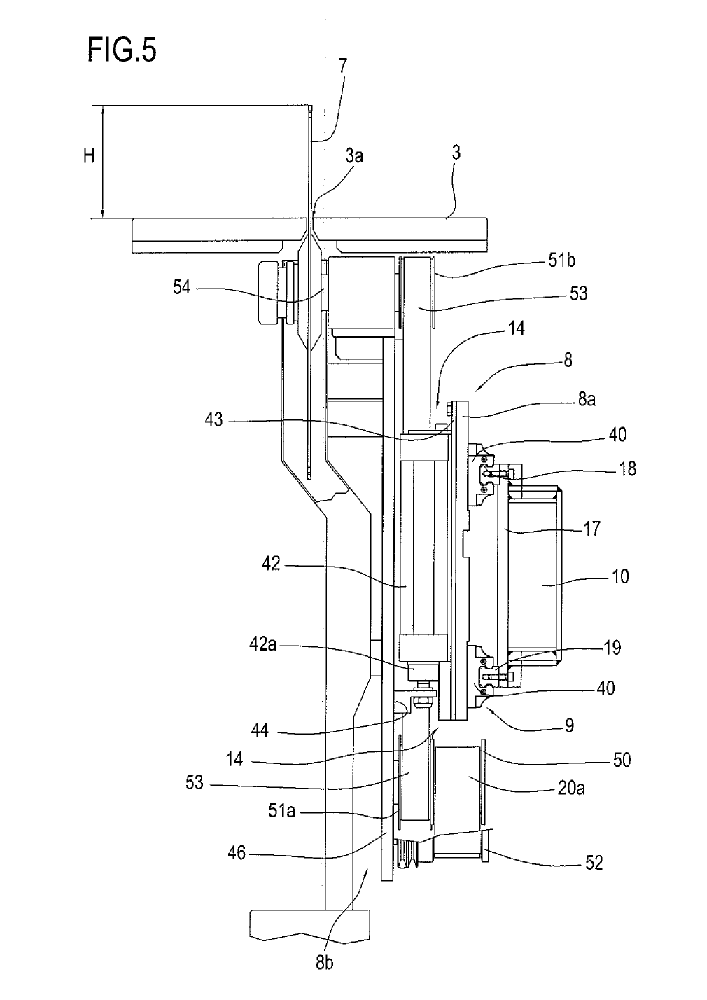

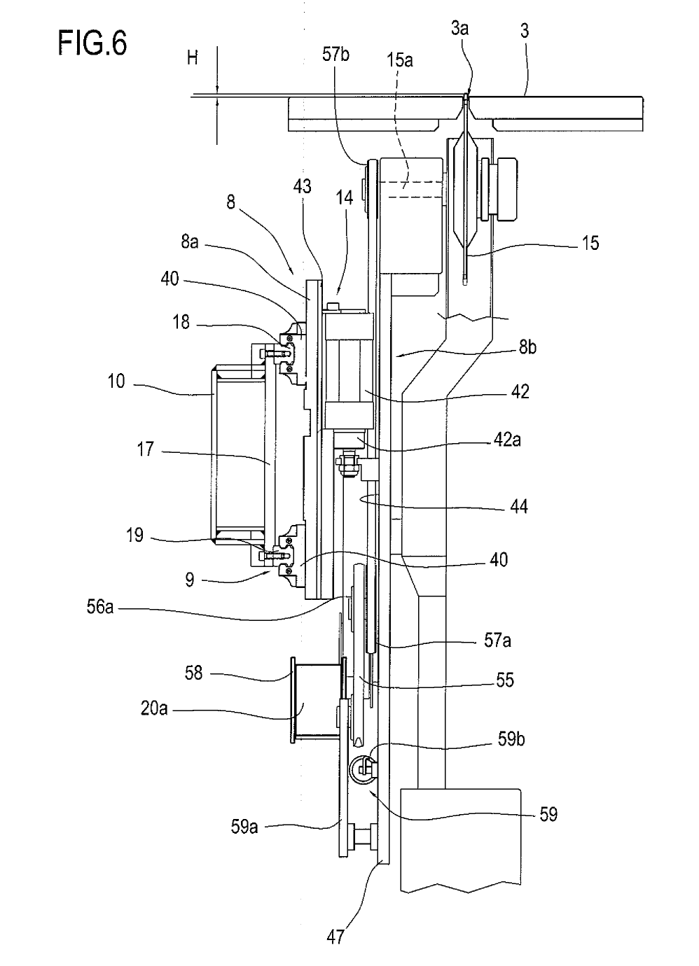

Returning now to the adjustment means 14 (see FIGS. 2 to 6), these are interposed between the horizontal guide means 9 and the carriage 8 so as to enable the carriage 8 to be lifted and lowered relative to the slot 3a: in this way, it is possible to vary the extent to which the first and second blades 7 and 15 protrude from the slot 3a, that is to say, to adjust the working part H of the scoring and cutting blades 7 and 15 that protrudes from the slot 3a.

Looking in more detail at the operating structure, the above mentioned first guides 18 and 19 have slidably mounted on them a first portion 8a of the carriage 8, equipped with respective counter-guides 40, and with a pair of second, vertical guides 41 slidably associated with a second portion 8b, mobile along the path Z, of the carriage 8.

The adjustment means 14 are interposed between the first and second portions 8a and 8b making up the carriage 8.

These adjustment means 14 may comprises at least one cylinder 42 fixed, at its lower end, to a front wall 43 of the first portion 8a and, at its rod 42a, to a rear wall 44 of the mobile portion 8b.

In the structure of the carriage 8 according to the invention as illustrated in FIGS. 2 to 6, the second, mobile portion 8b is divided into two half-parts 46 and 47, of which the one labelled 46 rotatably mounts the first blade 7 and the one labelled 47 rotatably mounts the second blade 15, or scoring blade.

Both the half-parts 46 and 47 are equipped with respective vertical counter-guides 41a and with the aforementioned adjustment means 14, which are interposed between the two half-parts 46 and 47 and the first portion 8a making up the carriage 8.

In other terms, the mobile portion 8b is structured as follows:
the first, mobile half-part 46 is equipped with two cylinders 42, forming part of the adjustment means 14, each fixed, at its lower end, to the front wall 43 of the first portion 8a and, at its rod 42a, to the rear wall 44 of the first, mobile half-part 46; said first, mobile half part 46 having associated with it a respective pair of vertical counter-guides 41a;
the second half-part 47 is equipped with a single cylinder 42 (smaller than the other two cylinders), forming the other part of the adjustment means 14 and fixed, at its lower end, to the respective front wall 43 of the first portion 8a and, at its rod 42a, to the rear wall 44 of the second half-part 47; said second half part 47 having associated with it a respective single vertical counter-guide 41a.

The two cylinders 42 of the first, mobile half-part 46 and the cylinder 42 of the second, mobile half-part 47 are controlled by the aforementioned machine control unit 45 (illustrated as a block in FIG. 4) which is designed to enable and disable the cylinders 42 in such a way that they can move in both directions (see arrows F42 and F42′ in FIG. 3), synchronously or independently between the first half-part 46 and the second, mobile half-part 47.

In other terms, the two half-parts 46 and 47 can slide along Z synchronously or independently according to the working requirements of the panel saw machine.

Returning now to the aforementioned transmission means, the first transmission means 13 are mounted on the first half-part 46 of the mobile portion 8b of the carriage 8, while the second transmission means 16 are mounted on both the first half-part 46 and on the second half-part 47 of the mobile portion 8b of the carriage 8.

More specifically, the first transmission means 13 (see FIGS. 3, 5 and 6 in particular) comprise at least one third pulley 50 which is rotatably associated with the first half-part 46 and which is engaged by the upper section 20a of the second belt 20 forming part of the second drive means 12.

The third pulley 50 is coaxially keyed to one of a pair of fourth pulleys 51a, 51b having a third, endless belt 53 trained around them. The other fourth pulley 51b is coaxially keyed to a shaft 54 that mounts the first blade 7 and rotationally drives the latter by transmitting the motion derived from the third pulley 50.

There is also another transmission pulley 52 for tensioning the section 20a of the drive belt 20.

The above mentioned second transmission means 16 comprise a fourth endless belt 55 trained around three fifth pulleys 56a, 56b, 56c, the one labelled 56a of which is coaxially keyed to a pulley 57a forming part of a pair of sixth pulleys 57a, 57b.

The other sixth pulley 57b is coaxially keyed to the shaft 15a of the second, scoring blade 15.

One of the fifth pulleys, namely the one labelled 56b, is keyed to the first half-part 46 of the mobile portion 8b of the carriage 8 in a position such that it engages, by means of a seventh pulley 58 coaxial with and keyed to the fifth pulley 56b itself, the upper section 20a of the second belt 20 and in such a way as to also rotate the second, scoring blade 15.

As mentioned previously, the two half-parts 46 and 47 can move independently of each other and thus, the second half-part 47 is equipped with a tensioning element 59 designed to adjust the second transmission means 16 relative to the first transmission means 13 according to the position of the two half-parts 46, 47 in height.

More in detail, the tensioning element 59 comprises an arm 59a pivoted at one end of it to the second half-part 47 and fixed at its other end to the fifth pulley 56c.

The arm 59a is retained by a tensioning spring 59b connected at one end to the arm 59a and at the other end to the second half-part 47: in this way, the arm 59b can swing in both directions (see arrow F59) according to the position of the fifth pulley 56b mounted on the first half-part 46, thereby adjusting the position of the fifth pulley 56c and keeping the fourth belt 55 tensioned.

A panel saw machine made as described above thus achieves the above mentioned aims thanks to a structure for driving and adjusting the blade carriage made extremely simple and light.

This is made possible by the fact that the mobile parts of the blade unit consist of a simple carriage with the two blades on it and a plurality of belts and pulleys mounted on a plate equipped with slide guides and on which there is only the system for driving the carriage drive pulleys.

The rotational drive of the blades, on the other hand, is indirect, independent of the carriage and accomplished by a belt and by the blade transmission elements: that means the moving parts are lighter in weight and there is no need for electrical and air connections that move along with the carriage, with obvious advantages in terms of machine reliability and safety.

Furthermore, the blades can be adjusted in height independently of each other thanks to a simple system of guides and cylinders mounted directly on the parts of the carriage.

This type of architecture, therefore, optimizes the cutting area, making it economical in terms of construction and reducing the number of moving cables and conduits and thus also reducing machine maintenance requirements and down time; moreover, this is achieved without reducing its adjustment capabilities and cutting performance, which are comparable to those of machines having more complex structures.

The invention described above is susceptible of industrial application and may be modified and adapted in several ways without thereby departing from the scope of the inventive concept. Moreover, all the details of the invention may be substituted by technically equivalent elements.

1. A panel saw machine for panels (1) made of wood or similar materials, the panel saw machine (2) comprising at least:
a horizontal table (3) for supporting the panels (1);
means (4) for advancing the panels (1) along a feed line (A), said means (4) being mobile in a direction parallel to and along the horizontal table (3);
a straight cutting unit (5) transversal to the feed line (A) and comprising at least one base (10), presser means (6) for holding down the panels (1), and a first saw blade (7) positioned close to the presser means (6), mobile in both directions and protruding lengthways from a slot (3a) made in the horizontal work table (3) in such a such a way as to cut the panels (1) along a line (T) transversal to the feed line (A), the panel saw machine (2) being characterized in that the cutting unit also comprises:
a carriage (8) which rotatably mounts the first blade (7) and which is slidably connected to horizontal guide means (9) along the line (T) and associated with the base (10);
adjustment means (14) acting on the carriage (8) and designed to enable the carriage (8) to move vertically in both directions along a line (Z) perpendicular to the transversal line (T); and
second means (12) for indirectly driving the first blade (7), mounted on the base (10) and kinematically connected, through first drive transmission means (13), to the first blade (7) in such a way as to enable the latter to rotate.

2. The machine according to claim 1, characterized in that it further comprises first means (11) for moving the carriage (8), allowing the carriage (8) to move in both directions along the transversal line (T).

3. The machine according to claim 1, characterized in that the adjustment means (14) are interposed between the horizontal guide means (9) and the carriage (8), and are designed to enable the carriage (8) to be lifted and lowered relative to the slot (3a) in such a way as to vary the extent to which the first blade (7) protrudes from the slot (3a), that is to say, to adjust the working part (H) of the cutting blade (7) that protrudes from the slot (3a).

4. The machine according to claim 1, characterized in that the carriage (8) has rotatably mounted on it a second blade (15), or scoring blade, positioned alongside the first, main blade (7), and connected to the second drive means (12) through second drive transmission means (16) in turn connected to the first drive transmission means (13) and mounted on the carriage (8).

5. The machine according to claim 1, characterized in that the guide means (9) comprise a horizontal plate (17) provided with a pair of first, fixed horizontal guides (18, 19) to which the carriage (8) is slidably constrained.

6. The machine according to claim 1, characterized in that the guide means (9) comprise a horizontal plate (17) provided with a pair of first, fixed horizontal guides (18, 19) to which the carriage (8) is slidably constrained; the first guides (18, 19) having slidably mounted on them a first portion (8a) of the carriage (8), equipped with respective counter-guides (40) and with a pair of second, vertical guides (41) slidably associated with a second, mobile portion (8b) of the carriage (8); said adjustment means (14) being interposed between the first and second portions (8a, 8b) making up the carriage (8).

7. The machine according to claim 6, characterized in that the adjustment means (14) comprise at least one cylinder (42) fixed, at its lower end, to a front wall (43) of the first, fixed portion (8a) and, at its rod (42a), to a rear wall (44) of the mobile portion (8b).

8. The machine according to claim 7, characterized in that the at least one cylinder (42) is controlled by a machine control unit (45) designed to enable and disable the cylinder (42) in such a way that it can move in both directions on the mobile portion (8b) of the carriage.

9. The machine according to claim 6, characterized in that the second, mobile portion (8b) is divided into two half-parts (46, 47), one of which (46) rotatably mounts the first blade (7) and the other rotatably mounts a second blade (15), or scoring blade; both the half-parts (46, 47) being equipped with respective vertical counter-guides (41a) and with the adjustment means (14), which are interposed between the two half-parts (46, 47) and the first portion (8a) making up the carriage (8).

10. The machine according to claim 9, characterized in that the first, mobile half-part (46) is equipped with two cylinders (42), forming part of the adjustment means (14), each fixed, at its lower end, to a front wall (43) of the first portion (8a) and, at its rod (42a), to a rear wall (44) of the first, mobile half-part (46); said first, mobile half part (46) having associated with it a respective pair of vertical counter-guides (41a).

11. The machine according to claim 9, characterized in that the second half-part (47) of the mobile portion (8b) is equipped with a cylinder (42), forming part of the adjustment means (14) fixed, at its lower end, to a front wall (43) of the first, fixed portion (8a) and, at its rod (42a), to a rear wall (44) of the second, mobile half-part (47); the second, mobile half-part (47) being associated with a respective vertical counter-guide (41a).

12. The machine according to claim 10, characterized in that the second half-part (47) of the mobile portion (8b) is equipped with a cylinder (42), forming part of the adjustment means (14) fixed, at its lower end, to a front wall (43) of the first, fixed portion (8a) and, at its rod (42a), to a rear wall (44) of the second, mobile half-part (47); the second, mobile half-part (47) being associated with a respective vertical counter-guide (41a), further characterized in that the two cylinders (42) of the first mobile half-part (46) and the cylinder (42) of the second mobile half-part (47) are controlled by a machine control unit (45) which is designed to enable and disable the cylinders (42) in such a way that they can move in both directions synchronously or independently between the first half-part (46) and the second, mobile half-part (47).

13. The machine according to claim 1, characterized in that the first transmission means (13) comprise at least one third pulley (50) which is rotatably associated with the carriage (8) and engaged by the upper section (20a) of a second belt (20) forming part of the second drive means (12); the third pulley (50) being coaxially keyed to one of a fourth pair of pulleys (51a, 51b) with a third endless belt (53) trained around them; the other fourth pulley (51b) being coaxially keyed to a shaft (54) that mounts the first blade (7) and rotationally drives the latter by transmitting the motion derived from the third pulley (50).

14. The machine according to claim 4, characterized in that the second transmission means (16) comprise a fourth endless belt (55) trained around three fifth pulleys (56a, 56b, 56c), one of which (56a) is coaxially keyed to a pulley (57a) forming part of a pair of sixth pulleys (57a, 57b), the other sixth pulley (57b) being coaxially keyed to the shaft of the second, scoring blade (15); one (56b) of the fifth pulleys (56a, 56b, 56c) being keyed to the carriage (8) in a position such that it engages, by means of a seventh pulley (58) coaxial with and keyed to the fifth pulley (56b), an upper section (20a) of a second belt (20) forming part of the second drive means (12) in such a way as to also rotate the second, scoring blade (15).

15. The machine according to claim 4, characterized in that the carriage (8) has rotatably mounted on it a second blade (15), or scoring blade, positioned alongside the first, main blade (7), and connected to the second drive means (12) through second drive transmission means (16) in turn connected to the first drive transmission means (13) and mounted on the carriage (8), further characterized in that the first transmission means (13) are mounted on the first half-part (46) of the mobile portion (8b) of the carriage (8), and the second transmission means (16) are mounted on both the first half-part (46) and on the second half-part (47) of the mobile portion (8b) of the carriage (8).

16. The machine according to claim 15, characterized in that second half-part (47) is equipped with a tensioning element (59) designed to adjust the second transmission means (16) relative to the first transmission means (13) according to the position of the two half-parts (46, 47) in height.
